(19) United States
(12) Patent Application Publication
(10) Pub. No.: US 2025/0165564 A1
(43) Pub. Date: May 22, 2025

(54) PRIVACY-PRESERVING CONTENT LICENSE KEY DISTRIBUTION

(71) Applicant: Adeia Guides Inc., San Jose, CA (US)

(72) Inventors: Ville Ollikainen, Vihti (FI); Anni Karinsalo, Oulu (FI); Pekka Koskela, Oulu (FI); Markku Kylänpää, Helsinki (FI)

(21) Appl. No.: 18/517,469

(22) Filed: Nov. 22, 2023

(51) Int. Cl. G06F 21/10; G06F 21/57

(52) U.S. Cl. CPC G06F 21/105; G06F 21/57

(57) ABSTRACT

Systems and methods are described for content license key distribution where the privacy of a user is preserved. A content request from a user is received by a content distributor, the content request including a content identifier and a user identifier. On verification that the request from the user is valid, the content distributor acquires a content license from a content supplier, verifies it, and sends the content license to the user such that the user may consume the content. The user's identity is kept private by the use of signed keys, one-time identifiers, and the use of encryption. In addition, a one-time identifier of the user may be validated by an attestation service.

### BACKGROUND

The present disclosure relates to methods and systems for content license key distribution. Particularly, but not exclusively, the present disclosure relates to privacy-preserving license key distribution.

### SUMMARY

The majority of digital content provision today involves a content license supplier providing access to digital content through a content distribution network to a user. As in other fields, many companies involved in content licensing and provision operate a business model which relies on gathering data on customer's habits and either using that data to pitch relevant services to the user, or selling that data onto third parties. Digital interaction now present in content provision means that collecting a large volume of data about a user's activities has become much easier.

In terms of network architecture, the present-day norm in content delivery is for content distributors to use content delivery networks to distribute content to servers close to media consumers, and to permit direct access to such media via so-called digital rights management so that media consumers can enjoy a high quality of network service when downloading or streaming media to their device. By sharing the storage and network bandwidth of many consumers in a local area, networks such as Peer-to-Peer (p2p) networks offer content distributors the prospect of further improved content delivery performance.

A problem that currently exists is that, when a user sends a request to view encrypted content to a content delivery network, the content data in the request (such as an identifier indicating the content requested by the user and indeed other information about the user) may be sensitive information (e.g., from the point-of-view of the user). Thus, the request to view the content may include and reveal sensitive information about the user to entities connected to the content delivery network, when combined with the data associable to the user (such as the identity of a user's device or the identity of a user) included in the content request. However, to comply with the request to view the encrypted content, the content delivery network requires at least some information to be revealed in order to fulfil the request.

Furthermore, in wireless communication, especially cellular technology, new services and service levels are enabled, having more speed and throughput. A need therefore exists to provide ways in which entities providing access to content are able to share and manage content efficiently across different services provided for different users.

A further problem is that the identity or location data of the user seeking access to the content may be sensitive. This may be an issue in a p2p environment, where, in principle, anyone can join the network and both receive and provide content. Thus, when seeking to access content, the user requires anonymization as to the source of the request to view the content, but still needs be able to access the content via the content delivery network.

There is therefore an increasing need for privacy protection for both the user and the content license provider.

According to an example of the systems and methods described herein, a content distributor or content distribution node receives a content request from a user node, the content request including a content identifier and a user identifier, and wherein the user identifier further comprises a public key of a user and a signed one-time identifier. In response to determining whether a signature used to sign the signed one-time identifier is valid, the content distribution node or content distributor generates a content supplier request from the content request, sends the content supplier request and the user identifier to a content supply node, and receives a content reply from the content supply node. According to an example, the content reply comprising a content encryption key and a content license identifier associated with the content supplier request and the signed one-time identifier. The content distribution node or content distributor generates a verification message from the signed one-time identifier, and the content license identifier, signs the verification message using a content distributor key, and sends, to the user node, the content encryption key, the content license identifier, and the signed verification message.

In some examples, the user identifier further includes a seed value for modification of the signed one-time identifier.

In some examples, the verification message is calculated and signed in a trusted execution environment.

In some examples, the content distributor or content distribution node receives a license verification request from the user node for a license stored on the user node, and determines whether a license associated with the license verification request from the user node is a duplicate license, and in response to determining that the license is a duplicate license, sends a request to the user node to modify the license on the user node, and sends, to a reporting node, a notification that the license is a duplicate license.

In some examples, the request to the user node to modify the license on the user node is a request to delete the license on the user node.

In some examples, the content reply is sent in a content decryption package.

In some examples, the content decryption package is encrypted.

In some examples, the content distributor or content distribution node receives a verification request from a user node for a content decryption package stored on the user node, the verification request including the content decryption package. According to an example, the content distribution node or content distributor decrypts the content decryption package, decrypts the content encryption key, one-time content license identifier, and signed verification message. According to an example, the content distribution node or content distributor determines that the decryption of both the content decryption package and the content encryption key, the one-time content license identifier, and the signed verification message were decrypted successfully. According to an example, the content distribution node or content distributor, in response to determining that both the content decryption package and the content encryption key, the one-time content license identifier, and the signed verification message were not decrypted successfully, sends a request to the user node to modify the content decryption package on the user node, and sends, to a reporting system, a notification that the content decryption package is a duplicate content decryption package.

In some examples, the request to the user node to modify the content decryption package on the user node is a request to delete the content decryption package on the user node.

According to another example of the systems and methods described herein, an identification service or identification node receives from a user node, using control circuitry, an ephemeral public key, receives a public key of the attestation node, sends to the user node an attestation request including the public key of an attestation node, receives from the user node a verification message signed with the public key of the attestation node, and in response to determining that the verification message is validly signed, receives from the attestation node, a signed one time identifier, and sends the signed one time identifier to the user node.

In some examples, the identification node generates an unsigned one-time identifier.

In some examples, the unsigned one-time identifier is generated from a seed value.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a system for anonymous Content License ID (‘CLID’) and Content Encryption Key (‘CEK’) distribution with a validity check.

FIG. 2 illustrates a block diagram showing components of an example system for content delivery, in accordance with some examples of the disclosure;

FIG. 3 illustrates a process flow for privacy-preserving content license key distribution.

FIG. 4 illustrates a flow chart of an example process for obtaining a signed one-time identifier.

FIG. 5A illustrates a process flow for a user obtaining a content license key from a content distributor;

FIG. 5B illustrates a flow chart of an example process for a user obtaining a license key from a content distributor;

FIG. 6A illustrates a process flow for obtaining acceptance from a license verification service;

FIG. 6B illustrates a flow chart of an example process for obtaining acceptance from a license verification service;

FIG. 7 illustrates a further flow chart of an example process for a user obtaining a license key from a content distributor; and

FIG. 8 illustrates a further flow chart of an example process for obtaining a signed one-time identifier.

### DETAILED DESCRIPTION

Described herein are systems and methods for Content License ID (‘CLID’) and Content Encryption Key (‘CEK’) distribution with a validity check which may be anonymous. It should be noted that a CEK on the device of a user device is, in general, processed in a Trusted Execution Environment (‘TEE’). The concept of a TEE is well-understood in the art.

Herein, messages transmitted between, for example, users and content distributors, and users and verification services are described using a modified semiformal Alice & Bob notation. Such notation assumes that messages are described in curly brackets optionally followed by the key that is used to encrypt the message. The notation used herein for keys includes the name of the actor and type of the key. For example, pk(A) is a public key of the actor A and sk(B) is a private key of the actor B. A message M encrypted by a public key of B is described as {M}pk(B). The notation also allows an additional specifier to specify that the key pair is ephemeral key pair. For example, an ephemeral public key of the actor B is marked as pk(Beph). Concatenated message fields, e.g., (M1 and M2), are presented as a comma separated list {M1, M2}. The character ‘#’ is used to specify a cryptographic hash algorithm. A specific notation for signed messages is also used herein, as those are typically represented as primitive operations in Alice & Bob notation that easily hides the semantics.

For example, for a message M signed by the actor A, the message and its signature may be presented as follows:
{M}{#M}sk(A)

However, it is also possible to use the following notation:
Signed{M}sk(A)

It should be noted, that as a best practice, a person skilled in the art may add a cryptographic nonce (random or pseudorandom number) to the messages, whenever the content of the message could, over time, be repeated in exactly the same way, enabling replay attacks. For clarity, in the notation herein, a nonce is not explicitly present if the nonce would have no other purpose.

Where reference is made herein to a “User”, it will be appreciated that a “User” may be an end user, and may make requests and receive messages through a user node, such as a user device. The terms “user”, “user node” and “user device” may be used interchangeably throughout.

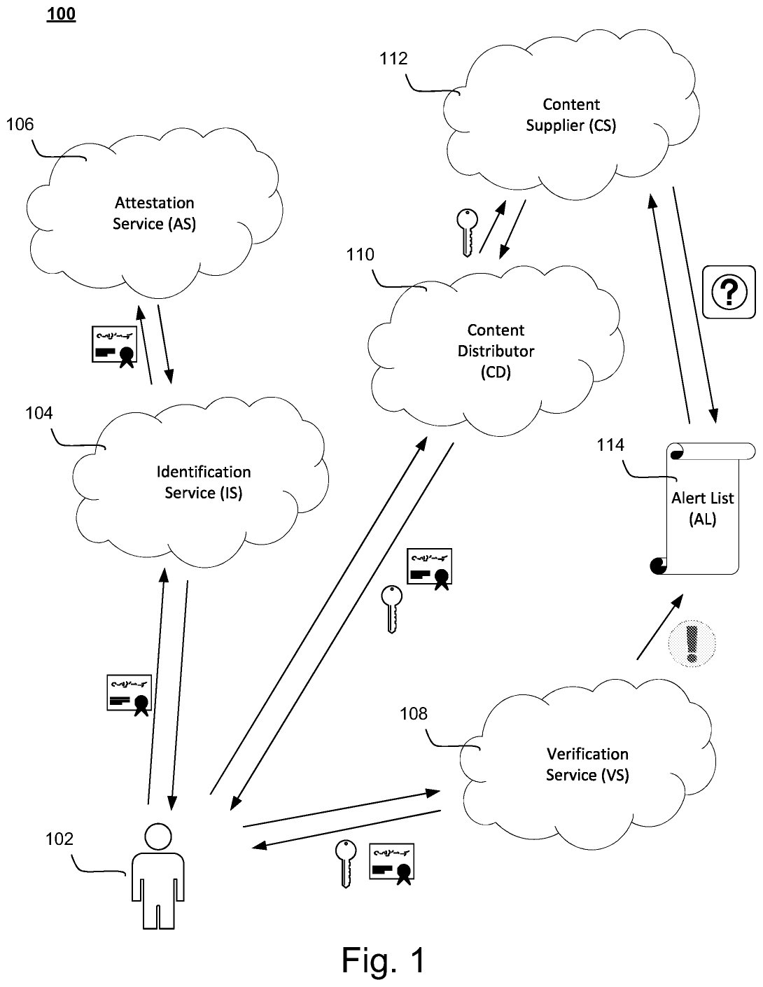

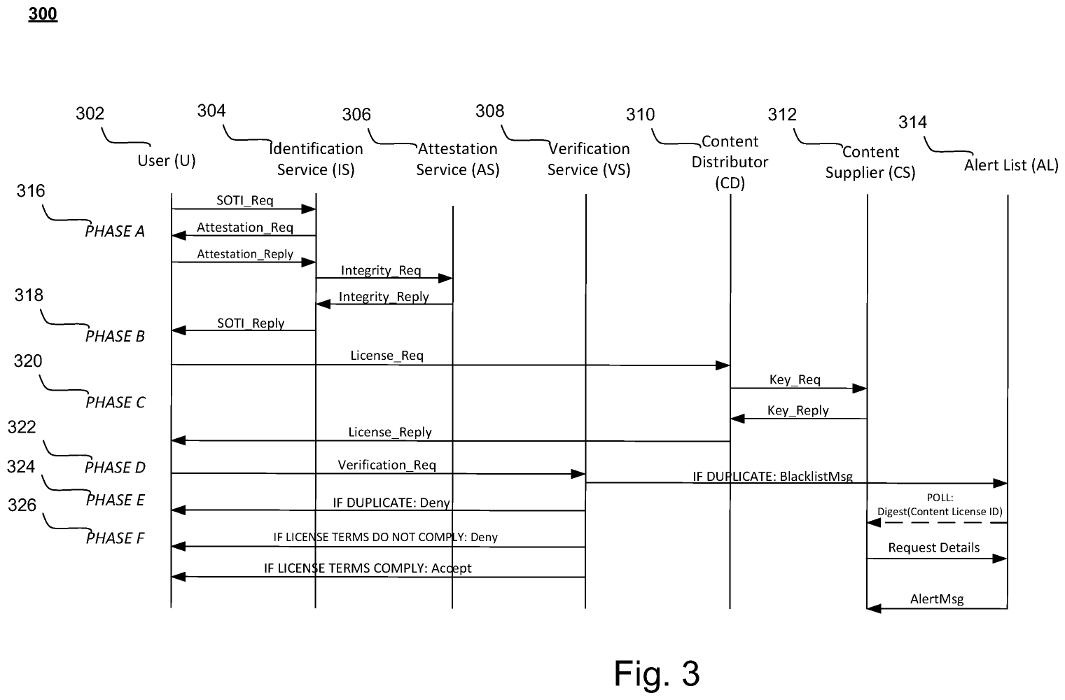

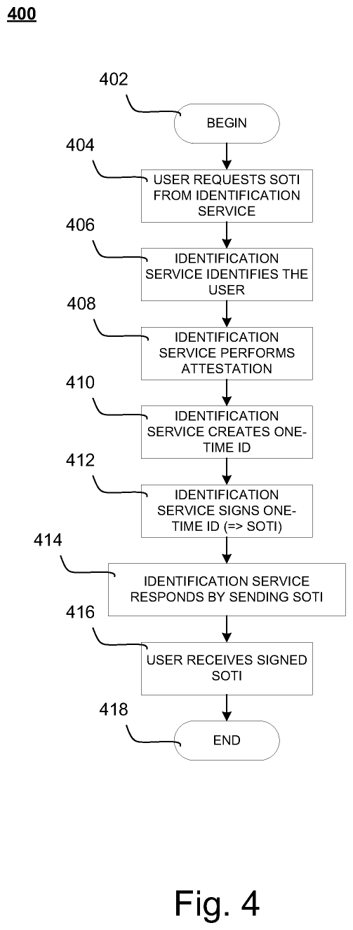

FIG. 1 illustrates an overview of a system 100 for anonymous Content License ID (‘CLID’) and Content Encryption Key (‘CEK’) distribution with a validity check. A User 102, by way of a device associated therewith, is associated with an Identification Service 104, a Content Distributor 110, also described herein as a content distribution node 110, and a Verification Service 108. As described herein and with reference to FIG. 3, and FIG. 4, the user 102 may request a Signed One-Time Identifier, SOTI, from the Identification Service 104.

The Identification Service 104 is in communication with an Attestation Service 106. The Attestation Service 106, in some embodiments, provides attestation of the Signed One-Time Identifier, SOTI, for the user 102. The SOTI, and optionally the attested SOTI, is sent from the Identification Service 104 to the User 102.

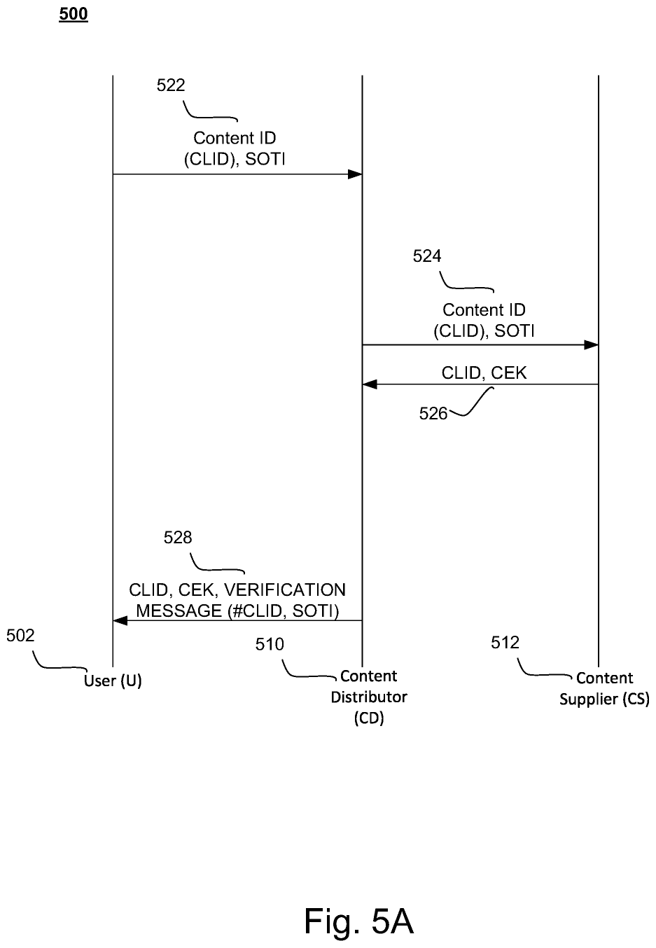

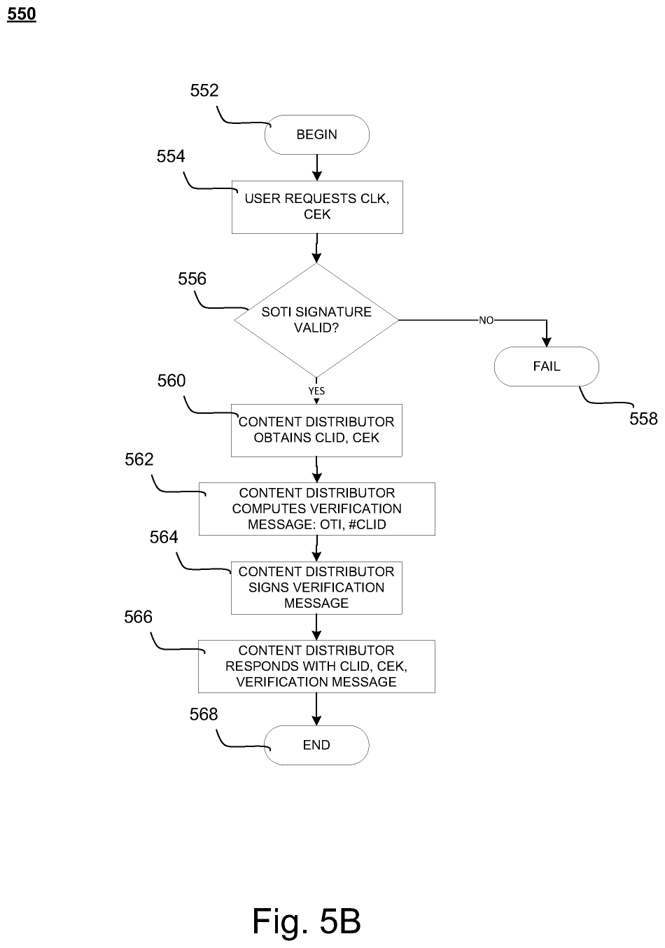

The User 102 requests, using a Content License ID (‘CLID’), a Content Encryption Key (‘CEK’) from the Content Distributor 110. As described herein and with reference to FIG. 3, FIG. 5A, and FIG. 5B, the User 102 sends their SOTI and the CLID to the Content Distributor 110.

The Content Distributor 110 is in communication with a Content Supplier 112 also described herein as a content supply node 112. The Content Distributor 110 sends the CLID and SOTI to the Content Supplier 112. The Content Distributor receives the CLID and CEK from the Content Supplier, signs the package of CLID and CEK, and transmits it to the User 102.

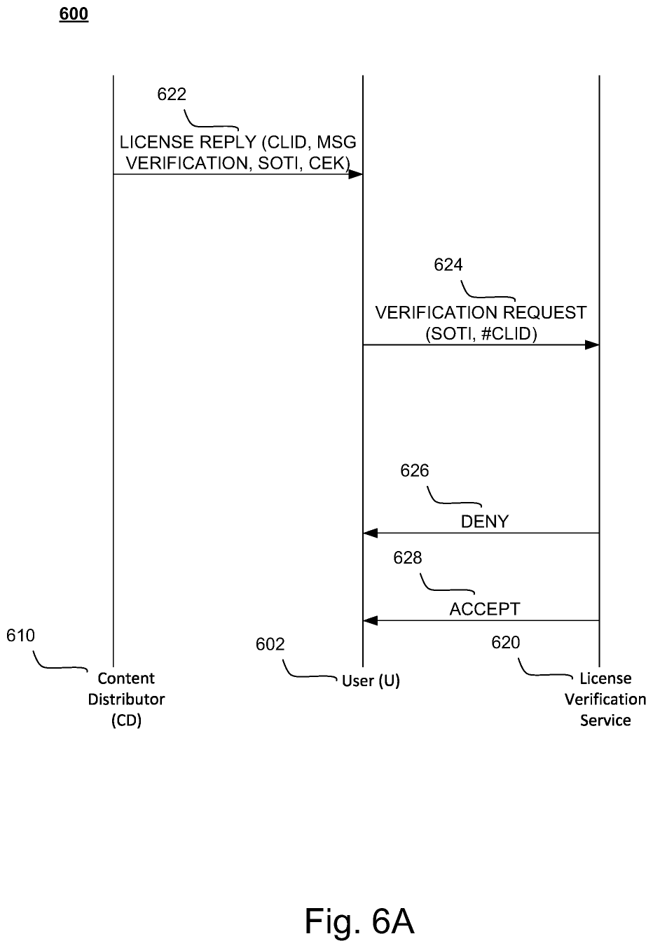

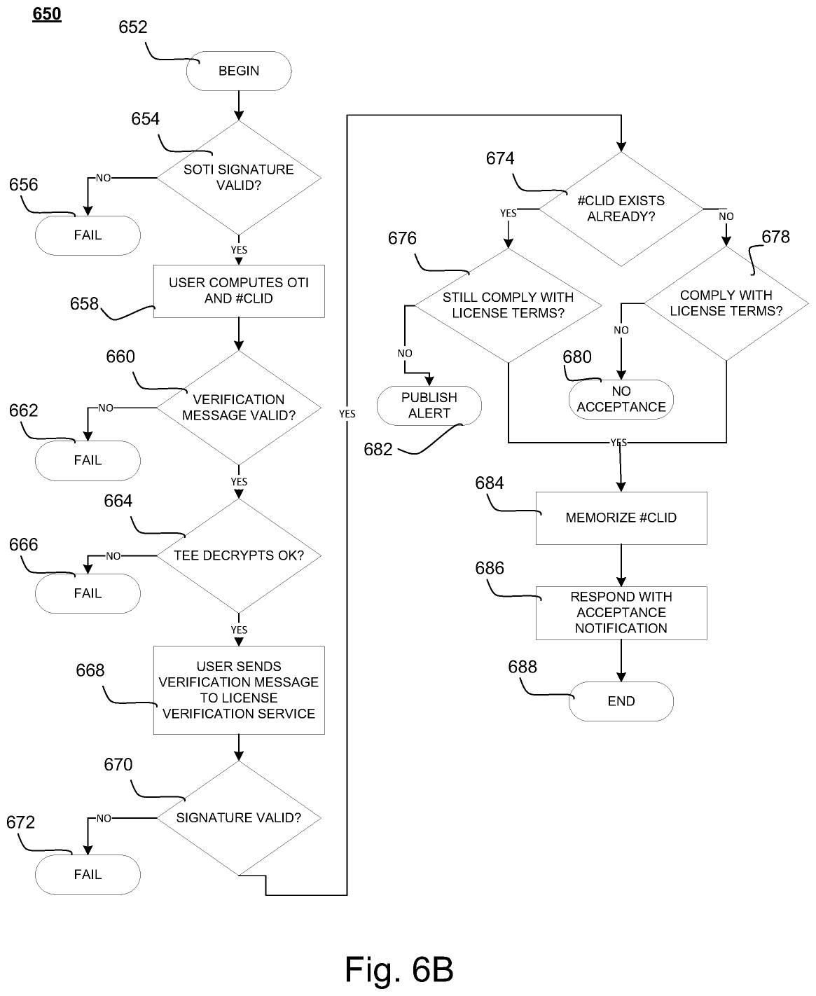

The user 102 is also in communication with a Verification Service 108. As described herein and with reference to FIG. 3, FIG. 6A, and FIG. 6B, the User 102 requests verification of the signed package of the CLID and CEK from the Content Distributor 110 by sending the same to the Verification Service 108. The Verification Service 108 sends confirmation of the validity of the signed package of the CLID and CEK received by the User 102 from the Content Distributor 110.

The Verification Service 108 and Content Supplier 112 are in communication with an Alert List 114. If the Verification Service 108 determines that the signed package of the CLID and CEK from the Content Distributor 110 is not valid, the Verification Service 108 sends an alert to the Alert List 114.

The Content Supplier 112 also requests verification of the request for the CEK from the Content Distributor 110 and if the request from the Content Distributor 110 is not valid, the Content Supplier 112 sends an alert to the Alert List 108.

The User 102, Identification Service 104, Attestation Service 106, Verification Service 108, Content Distributor 110, Content Supplier 112, and Alert List 114 may all be on different remote networks, partially on different remote networks, or in some cases, may all be part of the same network. In most cases, the User 102 will be remote from all of the other items shown system 100 of FIG. 1.

As is noted above, a content delivery network may comprise the distributor, and/or may form part of the chain of communication between the user and the content provider. For example, a content delivery network, such as a DRM API, may also comprise any, or any combination of, a license server which is a party providing the content encryption key (CEK) (e.g., to the content provider) and manages the license verification for the content, a user initializing the content request (e.g., by authenticating to the service) with a user node (e.g., user device), a content decryption module (CDM) which handles the decryption of the content (e.g., at the user node), and a device, which may be a platform, CDM, and/or browser with related applications (e.g., which negotiates with the License server), which sends the content request to the CDN.

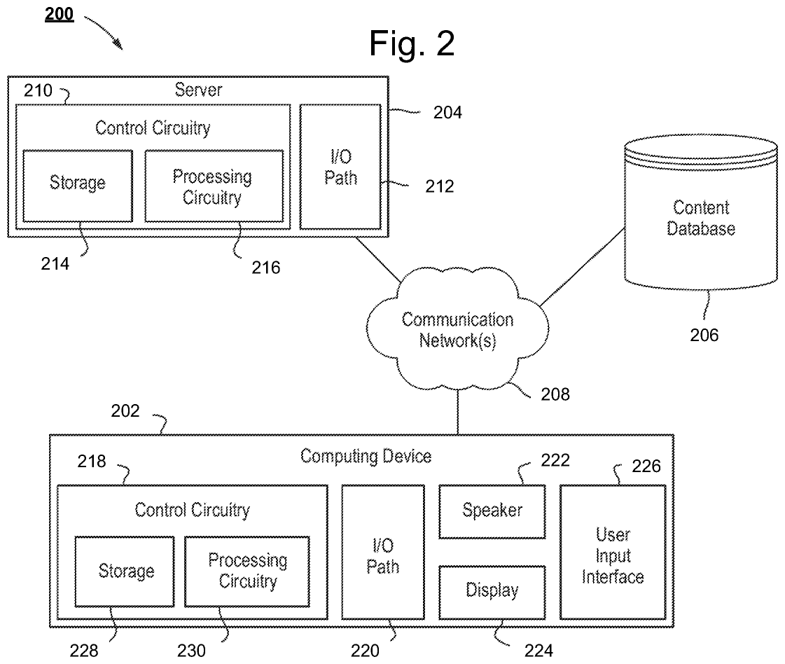

FIG. 2 is an illustrative block diagram showing example system 200, e.g., a non-transitory computer-readable medium, configured to distribute content, such as audio-video content. Although FIG. 2 shows system 200 as including a number and configuration of individual components, in some examples, any number of the components of system 200 may be combined and/or integrated as one device, e.g., as user node 102, distributor 104, content provider 106, and key manager 108. System 200 includes computing device n-202 (denoting any appropriate number of computing devices, such as user mode 102, distributor 104, content provider 106, and/or key manager 108), server n-204 (denoting any appropriate number of servers, such as distributor 104, content provider 106, and/or key manager 108), and one or more content databases n-206 (denoting any appropriate number of content databases), each of which is communicatively coupled to communication network 208, which may be the Internet or any other suitable network or group of networks, such as a content distribution network or content management network. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, or any other type of computing device, includes control circuitry 218, I/O path 220, speaker 222, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 (e.g., storages of content database 206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays are provided locally on computing device n-202. Computing device n-202 may receive inputs from the user via input interface 226 and transmit those inputs to the remote server for processing and generating the corresponding displays.

A computing device n-202 may send instructions, e.g., to request content, to control circuitry 210 and/or 218 using user input interface 226.

User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

With reference to FIG. 3, a user 302 may request, with an ephemeral public key, at least one signed one-time identifier (‘SOTI’) from an identification service 304.

The Identification Service 304 may create a One-Time Identifier (‘OTI’) for the user 302. It is a random value, and in some cases cryptographic nonce which may be signed by the Identification Service 304 to create a SOTI, shown in PHASE B 318 of FIG. 3 and discussed in more detail later. The Identification Service may sign the OTI together with a user's ephemeral public key, hence ‘Signed OTI’, or ‘SOTI’.

The Identification Service 304 may optionally require remote attestation, shown as part of PHASE A 316 of FIG. 3, for the clients before providing the SOTI to guarantee system integrity of the device of the user 302.

Transactions in the upper part of FIG. 3, denoted as being part of PHASE A 316 may include a user 302 (‘U’), an Identification Service 304 (‘IS’), and an Attestation Service 206 (‘AS’). The message or transaction exchange which forms PHASE A 316 is described below. The user may send a SOTI request to the Identification Service 304 with some authentication information to prove that the User 302 is an authorized DRM system user, along with the user's public key.

It may be taken that the authentication information may be something a user knows (e.g., password, PIN code), something the user has (e.g., token device), and/or something else to identify the user (e.g., fingerprint or face recognition). The authentication protocol and the data returned may depend on the authentication type. In some examples described herein, the authentication information can be a client certificate that is certified by a DRM system. In such a case, the client certificate can be used in secure connection establishment between the User 302 and the Identification Service 304 using a handshake that is a part of Transport Layer Security (TLS) RFC8446 authentication mechanism. Authentication information can also be a username and password pair, if the Identification Service 304 maintains a database of authorized DRM system users 302. The Identification Service 304 may also require Multi-Factor authentication (MFA).

The public key may optionally be a certified public key and authentication may include transactions that are not described in this scenario, related to, e.g., certificate chain checking. If a transaction occurring as part of PHASE A includes remote attestation, as described later herein, it is preferable that the key is a hardware-backed key that is based on security properties of the Trusted Execution Environment, (‘TEE’). In some cases, the request may be encrypted with the public key of the Identification Service 304.

An example message exchange, MSG01, as part of PHASE A 316, may include:
MSG01: (SOTI_Req): U→IS: {auth-info, pk(Ueph)}pk(IS)

As the next step, and still as part of PHASE A 316, the Identification Service 304 may perform remote attestation to verify User's TEE. For this, a request may be sent to the user 302. The message, an example shown below as MSG02, may include the public key of the Attestation Service 306:
MSG02: (Attestation_Req): IS→U: {pk(AS)} pk(Ueph)

The user 302 may reply to the request by providing attestation evidence that is encrypted using the public key of the Attestation Service 306. This information may be signed by the user 302. One example of attestation evidence is Trusted Platform Module (TPM) Platform Configuration Register (PCR) information. TPM functionality is typically included in devices such as PCs, servers, and laptops. During the boot phase of such devices, integrity measurements are generated of each component being a part of the boot chain by calculating cryptographic hash of the measured component before passing control to the component. The generated measurement log is then appended and some of the TPM PCR registers are updated. To attest the TEE of the user's device, a signed blob with PCRs and received nonce may then be passed to the remote party together with the measurement log. The remote party may then verify the evidence and also integrity of individual components against reference values.

The Android operating system provides the Play Integrity API (previously known as SafetyNet) that remote parties may use to request integrity verification of the Android device connecting to a remote service. The remote service can request different strength attestation and some of these options are implemented in isolated trusted hardware level in the Trusted Execution Environment (TEE). In the example described here, the attestation evidence that is returned is an integrity token that can be verified using Google Play service.

It should be noted that a person skilled in the art may also include such attestation related information to the message which need not be signed. For clarity, this is not described explicitly herein, but if included, also this field should be encrypted by the public key of the Attestation Service 306 so that it does not become visible to the Identification Service 304. An example of an attestation reply, MSG03, is given below.
MSG03: (Attestation Reply): U→IS: {Signed{{attestation-evidence} pk(AS)}sk(Ueph)}pk(IS)

The Identification Service 304 may verify the user's signature and may then pass encrypted attestation evidence information to the Attestation Service 306. In some cases, the signature verification may be delegated to the Attestation Service 306. Often-used signature algorithms are RSA and ECDSA. In an example, the Identification Service 304 can also delegate the signature checking to the Attestation Service 306, which can also combine device integrity verification with the signature verification.

An example integrity request, MSG04, is given below.

MSG04:(Integrity_Req): IS->AS: {{ attestation-
evidence}pk(AS), {attestation-info}pk(AS) }pk(AS)

The Attestation Service 306 may then reply with an integrity verification status, as shown in example integrity reply, MSG05, given below.
MSG05: (Integrity_Reply): AS→IS: {true-or-false}pk(IS)

The Identification Service 304 may then create the SOTI by signing the OTI and returning it to the user 302, if the user has been successfully authenticated, and remote attestation result was successful. In the case that there was an error, a failure message may be returned. An example SOTI reply, MSG06, is given below.

MSG06:(SOTI_Reply): IS->U: { SOTI, SIGNED_EPH }pk(Ueph)
SOTI = Signed{OTI}sk(IS)
SIGNED_EPH = Signed{pk(Ueph)}sk(IS)

The One-Time Identifier described herein may advantageously be a random 128-bit Globally Unique Identifier (GUID), which is used for the examples described herein and for any subsequent security discussions.

In an embodiment of the present disclosure, a signed ephemeral key is signed separately from an OTI. This is useful, because a signed OTI may be made public, and if the ephemeral key were to be published, it would enable the identity of the user to be made available to the Identification Service. This may be carried out under data protection regulations such as the General Data Protection Regulation, GDPR, which is a set of data protection rules that, in particular, impose bounds on what organizations may do with a user's personal data. In such a case, the identity of the user user 302 may be disclosed in the Alert List 314, described later herein.

The process of creating a SOTI may also contain identification of the user 302, e.g., email verification for example for billing purposes and suchlike.

FIG. 4 shows a flow chart describing how a user may obtain a signed one-time identifier, SOTI. This corresponds to PHASE A shown in FIG. 3.

The process 400 shown in FIG. 4 commences at block 402, and at block 404, a user 302 requests a Signed One-Time Identifier, SOTI, from the Identification Service 304. At block 406, the Identification Service 304 identifies the user 302, and in the example shown in FIG. 4, at block 408, the Identification Service 304 performs attestation of the identity of the user 302, such as described above in connection with FIG. 3.

At block 410, the Identification Service 304 creates a One-Time Identifier as described herein, and for example, the One-Time Identifier may be a random 128-bit Globally Unique Identifier (GUID). At block 412, the Identification Service signs the One-Time Identifier, to create the Signed One-Time Identifier. The process carried out by the Identification Service 304 at block 412 may be as described in relation to MSG06 above.

At block 414, the Identification Service 304 sends the Signed One-Time Identifier, SOTI, to the user 302, and at block 416, the user 302 receives the SOTI from the Identification Service 304. Process 400 ends at block 418 on successful completion.

With reference now to FIG. 5A, a message flow 500 is shown. When a user 502 (which may correspond to user 302) requests 522 a one-time (unique) Content License ID (CLID), together with content-specific Content Encryption Key (CEK) from the Content Distributor 510, as part of request operation 522, the user 502 may send to the Content Distributor 510 a content ID, along with the ephemeral public key of the user 502, and the SOTI, signed by the identification service 304 described above. Request operation 522 may include user 502 and Content Distributor 510 which may be connected to different remote networks.

The Content Distributor 510 sends a request 524 to the Content Supplier 512 which includes the Content License ID (CLID) and the SOTI signed by the identification service 304 as described above. The Content Distributor 510 request 524 to the Content Supplier 512 causes the Content Supplier 512 to respond 526 to the Content Distributor 510 with the one-time (unique) Content License ID (CLID), together with content-specific Content Encryption Key (CEK). The Content Supplier 512 and Content Distributor 510 may be connected to different remote networks.

The Content Distributor 510 then transmits 528 the one-time (unique) Content License ID (CLID) to the user 502, together with content-specific Content Encryption Key (CEK) and a verification message. In some embodiments the verification message includes a hash of the CLID and the SOTI. In some embodiments, the Content Distributor 510 signs the verification message. Once the CLID and CEK are received by the user 502, the user may decrypt the content.

The process 550 shown in FIG. 5B corresponds to the message flow 500 shown in FIG. 5A. The process 550 commences at block 552, and at block 554, user 502 requests the one-time (unique) Content License ID (CLID), together with content-specific Content Encryption Key (CEK) from the Content Distributor 510 by transmitting the request with the SOTI of the user 502. This block is analogous with request operation 522 shown in FIG. 5A.

At block 556, the Content Distributor 510 checks the validity of the SOTI, and makes a determination as to whether to proceed with process 550. If the verification of the SOTI signature fails because the SOTI is determined to be invalid, the process terminates in a fail condition at block 558. If the verification of the SOTI signature succeeds because the SOTI is determined to be valid, the process continues to block 560.

At block 560, the Content Distributor 510 requests, from the Content Supplier 512, the one-time (unique) Content License ID (CLID), together with content-specific Content Encryption Key (CEK) by transmitting, to the Content Supplier 512, the Content License ID (CLID) and the SOTI signed by the identification service 304 of FIG. 3 as described above. This block is analogous with the request 524 to the Content Supplier 512 shown in FIG. 5A.

At block 562, the Content Distributor 510 computes the verification message which, as described above, may include or consist of a hash of the CLID and the SOTI. On computing the verification message, the process may advance to block 564. At block 564, Content Distributor 510 signs the verification message, and on signing the verification message the process advances to block 566. At block 566, the Content Distributor 510 responds to the user 502, sending the CLID, CEK, and verification message such that the user 502 may decrypt the content. On successful transmission of the CEK, CLID, and verification message to the user, the process may terminate at block 568.

In some embodiments, a Random Value for One-Time Identifier Modification (RNDOTIM) may be utilized. Message transactions during PHASE B 318 shown in FIG. 3 (and also during PHASE C 320 of FIG. 3 may include transactions between the user 302, Content Distributor (CD) 310, and Content Supplier (CS) 312. The user 302 may send a license request to the Content Distributor 310 including the Content ID (which specifies the media content to be requested), the SOTI as discussed herein and received from the Identification Service 304, the RNDOTIM, and ephemeral public key of the User 302. The User 302 may utilize the ephemeral key pair in this transaction (cf. pk (U) given below) to prevent linking of multiple content transactions which may allow profiling the user.

The structure of an example license request message, MSG07, is given as:

MSG07:(License_Req):
U->CD: { ContentID, SIGNED_EPH, SOTI }pk(CD)
SIGNED_EPH = Signed{pk(Ueph)}sk(IS) [from MSG06]
SOTI = Signed{OTI}sk(IS) [from MSG06]

Returning to FIG. 3, at PHASE C 320, in responding to the content license request, the Content Distributor 310 may verify the signature of said SOTI, obtain a content encryption key (‘CEK’) and one-time CLID of the requested Content ID from a Content Supplier as described with reference to FIG. 5A and FIG. 5B herein. Communication between the Content Distributor 310 and Content Supplier 312, is described in more detail below, with message notation for messaging between Content Distributor 310 and Content Supplier 312 given as CD->CS and CS->CD respectively. As described above and in connection with FIG. 5A and FIG. 5B, the Content Distributor 310 may also compute a Verification Message, which includes the One-Time Identifier (OTI), a Digest of the CLID (#CLID), and in some cases an identifier of the Content Distributor 310. The Content Distributor 310 may then sign the Verification Message and may then send at least the CLID, the CEK and the Verification Message as the response.

In an embodiment, the Content Distributor 310 does not have access to or direct knowledge of the CEK, which may be advantageous because honesty and/or integrity of a Content Distributor 310 cannot be guaranteed in all cases. In such a case, for each CEK, the Content Distributor 310 sends a request to the Content Supplier 312 for the Content Encryption Key (CEK), as given in MSG08 set out below:

MSG08:(Key_Req):
CD->CS: { ContentID, SIGNED_EPH, pk(CD) }pk(CS)
SIGNED_EPH = Signed{pk(Ueph)}sk(IS) [from MSG07]

The Content Supplier 312 may encrypt the CEK with the ephemeral public key of the user 302, for the Trusted Execution Environment, TEE, of the user's device, which may be described as pk(Ueph), so that the Content Distributor 310 cannot obtain the CEK. The Content Supplier 312 may also sign the encrypted CEK, such that the Content Distributor 310 is not able to act as a man-in-the-middle, with an example signing of the CEK shown as MSG09 below.

MSG09:(Key_Reply):
CS->CD: { CLID, SIGNED_ENCRYPTED_CEK }pk(CD)
SIGNED_ENCRYPTED_CEK = Signed{{CEK}pk(Ueph)}sk(CS)

In a similar way to that described above in connection with FIG. 5A and FIG. 5B, the Content Distributor 310 may then pass the license back to the User 302, as shown in MSG10 below.

MSG10:(License_Reply):
CD->U: { Signed{ CLID, VERIFICATION_MESSAGE,
SIGNED_ENCRYPTED_CEK }pk(Ueph)
VERIFICATION_MESSAGE = Signed{ SOTI, #CLID,
ContentDistributorID }sk(CD)
where SOTI = Signed{OTI}sk(IS) [from MSG07]
SIGNED_ENCRYPTED_CEK = Signed{{CEK}pk(Ueph)}sk(CS) [from
MSG09]

As described above and in connection with FIGS. 5A and 5B, the Verification Message may be signed by the Content Distributor 310. The reason for the signature is that if there was any misuse, the Content Distributor 310 which is involved in the action is disclosed. Since this Verification Message is subject to publishing, the CLID is not included as such, but a digest of it instead; that is to say if the CLID was used twice, also its digest will appear twice, thus demonstrating the wrongdoing. Any suitable one-way function may be used to generate a digest of the CLID. The one-way function is used to obfuscate or hide clear text such that it does not appear in a public log. Typical examples of a one-way function which may be used are SHA1, SHA256, and SHA512 algorithms.

The Verification Message may optionally also include license terms, such as the expiration date and time of the license, along with the user's right to consume the content several times. The Content Distributor 310 may record the SOTI and said OTI for subsequent purposes, such as billing. However, for privacy purposes, information about said Media Content, CLID or even #CLID may not be recorded, since those could reveal the viewing history of a user 302.

PHASE D 322 of FIG. 3 will now be discussed. This and the following phase, PHASE E 324 are set out in FIG. 6A and FIG. 6B.

With reference now to FIG. 6A, a message flow 600 is shown. The Content Distributor 610, which may correspond to Content Distributor 310, 510, sends 622 the license reply to the user 602, which may correspond to user 302, 502. The license reply may include, as described herein, the Content License ID (CLID), the verification message, the SOTI, and the Content Encryption Key (CEK). The user 602 receives the license reply from the Content Distributor 610.

Upon receiving the license reply, the user 602 may verify the signature of the Verification Message from the Content Distributor 610, and may also verify the correctness of said OTI and said #CLID by also computing it locally.

In an embodiment, the user 602 sends 624 the Content License ID and Content Decryption Package to the local TEE of the device of the user 602, which may then decrypt the Content Decryption Package with its private key and subsequently decrypt the result with the Content License Key. If either such decryption fails, this may lead to an error. In an error state, a verification message may be sent 624 to a License Verification Service 620.

This verification message transaction involves the User (U) 602 and a License Verification Service (VS) 620 as shown in FIG. 6A, and an example is shown in MSG11:

MSG11:(Verification_Req):
U->VS: {VERIFICATION_MESSAGE}pk(VS)
VERIFICATION_MESSAGE = Signed( #CLID, SOTI,
ContentDistributorID }sk(CD) [from MSG10]

Upon receiving the Verification Message, the License Verification Service 620 may verify the signature of the Verification Message of the Content Distributor 610, and it is noted that a list of authorized Content Distributors 610 may be published separately.

The License Verification Service 620 may compare the received hash of the Content License ID (#CLID) with previously received #CLIDs, and if the #CLID has been received previously and optionally in the case that license terms conflict, an alert may be raised with the License Verification Service sending 626 a deny message to the device of the User 602, which may result in the User 602 not being permitted to decrypt the licensed content.

If the #CLID has not been received previously at the License Verification Service 620, and/or where optional license terms do not conflict, the #CLID may be saved by the License Verification Service 620, along with the SOTI and the optional license terms, and the License Verification Service may send 628 an accept message to the device of the User 602, such that an Acceptance Notification is sent to the User as a response.

The alert may contain at least the identification of the Content Distributor 610, based on its ID, and may also include a CLID_D, a Content License ID Digest, as described above. In some cases, the alert is published, and Content Suppliers may check from time to time if any #CLIDs in the alerts have originated from them. In such an arrangement, the alert list may be publicly available.

Upon receiving the Acceptance Notification response from the License Verification Service 620, the User 602 can begin to consume the content from the TEE and media decoder controlled by it in a known fashion.

A person skilled in the art may appreciate that a push-method may be employed to deliver the alert to a specific Content Supplier 512, if the Content Supplier's identity may be included in the verification message.

The process 650 shown in FIG. 6B corresponds to the message flow 600 shown in FIG. 6A. The process 650 begins when the Verification Message has been received by the user 502, and commences at block 652 and advances to block 654. At block 654, at the device of the user 502, a validity check is performed on the signature used to sign the SOTI. This check may be a checksum, hash check, or any suitable check. If the check of the signature fails, the process advances to block 656 and fails. If the check of the signature succeeds, the process advances to block 658.

At block 658, at the device of the user 502, a computation is performed to calculate the OTI and the hash of the Content License ID (#CLID), by computing the OTI and the #CLID locally. The OTI may be calculated using a brute-force method which is discussed herein. The process then advances to block 660, and a check is performed to establish whether the verification message is correct based upon the calculation performed at block 658. If the check of the correctness of the OTI and #CLID fails, the process advances to block 662 and fails. If the check of the correctness of the OTI and #CLID succeeds, the process advances to block 664.

At block 664, at the device of the User 502, the Content Decryption Package is decrypted with its private key and the result is subsequently decrypted with the Content License Key. A determination is made as to whether either such decryption fails. If either such decryption fails, the process may move to block 666 and return an error state. If the decryption succeeds, in this case both decryptions, the process may advance to block 668. At block 668, as described above, the device of the User 502 sends a verification message to the License Verification Service 620 and the process advances to block 670.

At block 670, a determination at the License Verification Service 620 is made as to whether the signature of the Content Distributor 610 was used to sign the Content Decryption package, using techniques and methods described herein. In the case that the signature is determined not to be valid, the process advances to block 672 and returns an error state. If the signature is determined to be valid, the process advances to block 674.

At block 674, as described in connection with FIG. 6A above, at the License Verification Service 620, a comparison is made between the received hash of the Content License ID (#CLID) with previously received #CLIDs. If the #CLID has been received previously the process advances to block 676, and if the #CLID has not been received previously, the process advances to block 678.

At block 676, a determination is made as to whether the User 602 indicates continued adherence to license terms, which may be optional license terms as described in connection with FIG. 6A.

If the User 602 indicates that they will not adhere to the license terms, the process advances to block 682 and the process ends, and an alert may be raised with the License Verification Service sending a deny message to the device of the User 602. If the user 602 indicates that they will adhere to the license terms, the process advances to block 684.

At block 678, a determination is made as to whether the user 602 will adhere to license terms.

If the User 602 indicates that they will not adhere to the license terms, the process advances to block 680 and the process ends, and the License Verification Service may optionally send a deny message to the device of the User 602. If the user 602 indicates that they will adhere to the license terms, the process advances to block 684.

At block 684, if the #CLID has not been received previously at the License Verification Service 620, and/or where optional license terms do not conflict, the #CLID is saved or memorized by the License Verification Service 620. Optionally, this may be saved along with the SOTI and the optional license terms. The process then advances to block 686.

At 686, the License Verification Service sends an acceptance notification or accept message to the device of the User 602. The process 600 then advances to 688, and terminates with the User 602 being able to decrypt the content in a known fashion.

Blocks 676, 678, and 682 and associated blocks 680, and 682 correspond to the portion of FIG. 3 denoted PHASE F 326.

In an embodiment which relates to the calculation of the verification message 562 shown in FIG. 5B, the One-Time Identifier (OTI) is modified in a way, that no entity in the system can deterministically select the digest value. Yet, the user can verify (by brute force) that the digest indeed originated from data they sent to the Content Distributor.

For modification, a Random Value for One-Time Identifier Modification RNDOTIM is introduced. It advantageously contains a value with equal number space as said SOTI (e.g., 128 bits), having a limited population count (‘popcount’) in binary representation, i.e. a maximum numbers of bits set as ones, and an example popcount may be 3 or above. RNDOTIM is used to prevent any attack, in which a dishonest Identification Service would provide a definite OTI to track the user on later phases, e.g. in Alert Lists.

The structure of the license request message, MSG07A with RNDOTIM is:

MSG07A (License_Req):
U->CD: { ContentID, SIGNED_EPH, SOTI, RNDOTIM }pk(CD)
SIGNED_EPH = Signed{pk(Ueph)}sk(IS) [from MSG06]
SOTI = Signed{OTI}sk(IS) [from MSG06]

The OTI is modified by the RNDOTIM in the License Reply from the Content Distributor 510 to the User 502. The SOTI is the signed version of the OTI, and as such, the OTI can be extracted from the signed message.

Building on MSG09 and MSG10 described above, the following License Reply, MSG10A, occur:

MSG10A (License_Reply):
CD->U: { Signed{ CLID, VERIFICATION_MESSAGE2,
SIGNED_ENCRYPTED_SEK }pk(Ueph)
VERIFICATION_MESSAGE2 = Signed{ #CLID, OTINEW,
ContentDistributorID }sk(CD)
OTINEW = #{f(OTI,RNDOTIM)}
SIGNED_ENCRYPTED_CEK = Signed{{CEK}pk(Ueph)}sk(CS) [from
MSG09]

In such a case, only the digest of modified OTI is presented to the License Verification Service (VS) as part of MSG11A:

MSG11 (Verification_Req):
U->VS: {VERIFICATION_MESSAGE2}pk(VS)
VERIFICATION_MESSAGE2 = Signed{ #CLID, OTINEW,
ContentDistributorID }sk(CD) [from MSG10]
OTINEW = #{f(OTI,RNDOTIM)} [from MSG10]

This way, if the new OTI, OTI_{new} ever becomes published, e.g. in the Alert List, it would be hard even for the Identification Service 308 of FIG. 3 to detect, who are the Users in said Alert List. With reference to block 562 shown in FIG. 5B, the Content Distributor 510 computes new a OTI from the original OTI (retrieved from the SOTI signed by the Identification Service) and the RNDOTIM, e.g. by using XOR as function f( ) such that:

$$OTI new = HASH ( ( OTI original ) XOR ( RNDOTIM ) ) .$$

Therefore, a cryptographic digest (HASH) is computed, as an one-directional function guaranteeing that the original OTI cannot be computed from the resulting new OTI. The result will have no resemblance with the original value. If the population count of the RNDOTIM is e.g. 4, i.e. four bits in the 128-bit OTI are changed; the number of OTI modifications can be calculated as a very large number, such that:

$$N modifications = ( \begin{matrix}128 \\ 4\end{matrix} ) i . e . 10 , 668 , 000 \approx {2}^{23} .$$

However, to prevent a user 502 from determining the outcome it is advantageous that also the Content Distributor 510 modifies said RNDOTIM, for example by changing e.g. 1 bit more. In this way, the user 502 still can verify in step 660 of FIG. 6B that the new OTI originates from the original OTI, by checking with brute force all numbers with one bit difference from the original OTI, i.e. computing all 128 variations (in the example of one bit change) and computing the digest in 658 of FIG. 6B, if any of these match with the new OTI. For the outcome, the number of OTI modifications in the example will rise to an even larger number, such that:

$$N modifications = ( \begin{matrix}128 \\ 4\end{matrix} ) i . e . 264 , 566 , 400 \approx {2}^{28} .$$

In some embodiments, all communications between a User 502 and a Content Distributor 510 take place over onion or other secure routing, for true anonymity, to hide even IP address of the user 502.

In the present disclosure, 128-bit GUIDs may be used everywhere. Some further considerations are as follows. Firstly, the honesty of Identification Service 510 should be considered. In block 654 of FIG. 6B, the Identification Service 304 creates the Signed One-Time Identifier (SOTI). Since it is signed by the Identification Service 304, which is may advantageously be a service operated by a Content Distributor 310, and may be an alternate Content Distributor 310, the origin of the SOTI can be verified at any time, e.g. in such a way as described in FIG. 5B. Also, if the Identification Service 304 turns out dishonest, all SOTIs it has issued can be revoked by means designed by a person skilled in the art.

Secondly, obtaining the Content License Key should be considered. In block 560 of FIG. 5B, it is envisaged that a person skilled in the art can arrange a secure process for the Content Distributor 310 to obtain a Content License Key from a Content Supplier 312.

Thirdly, with respect to the embodiment which describes the use of RNDOTIM above, and with reference to block 562 of FIG. 5B, the Content Distributor 310 modifies the One-Time Identifier using RNDOTIM. The One-Time Identifier is provided to the License Verification Service 308 for publishing in the Alert List. From there, because the License Verification Service 308 knows the identity of the User 302, it may therefore detect the User 302 in the published information.

The present disclosure considers the following. The Content Distributor 310 cannot deliver multiple copies of the same license, because the License Verification Service 308 will detect such an attempt. The Content Provider 312 will not know the identity of Users 302. The License Verification Service 308 does not know the identity of Users 302. The License Verification Service 308 does not know what the content is. Further, since the Session ID is unique, the License Verification Service 308 cannot detect returning Users 302.

In addition, the present disclosure considers the following. If the Content Distributor 310 attempts to make the identity of the User 302 compromised by using the same Session ID, the User 308 would detect such from the received verification as described herein. The User 302 cannot report fake Content Distributor 310 IDs in connection with a Content License because the #CLID and Content Distributor 310 ID is signed by the Content Distributor 310. For similar reasons, the User 302 cannot report a false or spoofed #CLID. Further, the Content Distributor 310 cannot fake or spoof its own identity in Verification Messages because it has signed the relevant verification, including using the ID of the Content Distributor 310.

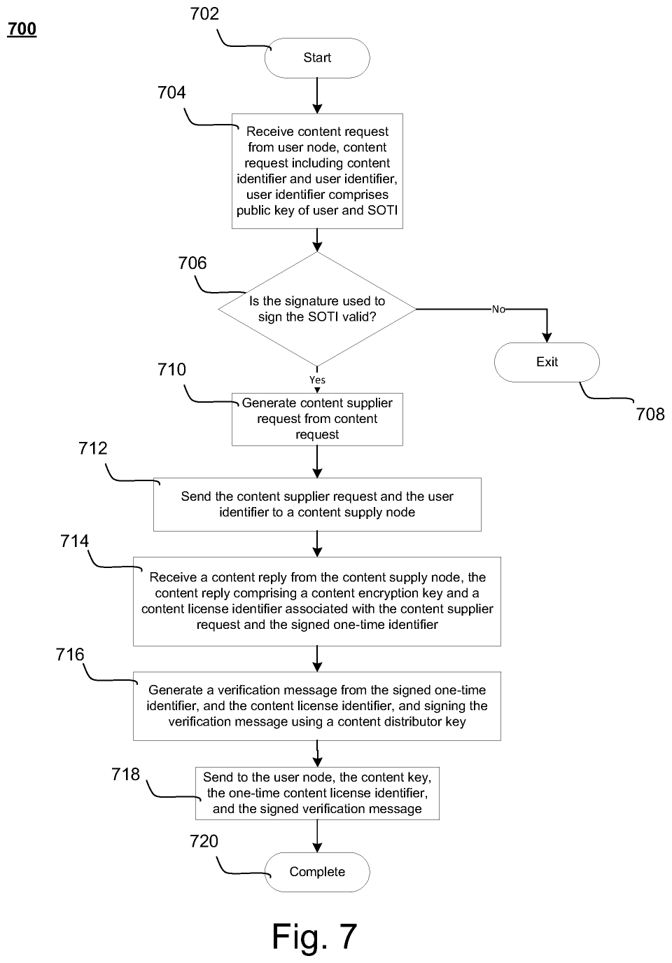

With reference to FIG. 7, an illustrative process 700 which occurs at the Content Distributor 310 and may correspond with that shown in FIG. 3.

At block 702, the process starts. At point 704, the Content Distributor 310 receives a content request from a user node, the content request including a content identifier and a user identifier. The user identifier comprises the public key of the user and the Signed One-Time Identifier, SOTI. In some examples, the content request includes a request for specific content, or for a specific media content item. In some examples, the content request may be a request for a series or season of media items. The content request may be transmitted in plain text or may be encrypted. The process then advances to block 706.

At block 706, a determination is made as to whether the signature used to sign the SOTI is valid. If the signature used to sign the SOTI is valid, the process advances to block 710. If the signature used to sign the SOTI is not valid, the process advances to block 708 and exits. The SOTI is, in some examples, signed as described as part of PHASE A 316 of FIG. 3, and using MSG01, MSG02, and MSG03 described herein at the device of the User 302. The Content Distributor 310 may compare a checksum of the signed SOTI with a known good checksum.

At block 710, the Content Distributor 310 generates a content supplier request from the content request, and at block 712, the Content Distributor 310 sends the content supplier request to a content supply node which in some examples is the Content Supplier 312 described herein. In some examples, the content supplier request includes a request for specific content, or for a specific media content item. In some examples, the supplier content request may be a request for a series or season of media items. The supplier content request may be transmitted in plain text or may be encrypted.

The Content Distributor 310 may send a request to the Content Supplier 312 which includes the Content License ID (CLID) and the SOTI signed by the identification service 304 as described above. The Content Distributor 310 request to the Content Supplier 312 may cause the Content Supplier 312 to respond to the Content Distributor 310 with the one-time (unique) Content License ID (CLID) described herein, together with a content-specific Content Encryption Key (CEK). The process then advances to block 714.

At block 714, the Content Distributor 310 receives a content reply from the content supply node, the Content Supplier 312, the content reply comprising a content encryption key and a content license identifier associated with the content supplier request and the signed one-time identifier. As described above, content reply may include the one-time (unique) Content License ID (CLID) described herein, together with a content-specific Content Encryption Key (CEK).

At block 716, the Content Distributor 310 generates a verification message from the signed one-time identifier, and signs the verification message using a content distributor key. The process then advances to block 718. In some embodiments the verification message includes a hash of the CLID and the SOTI. In some embodiments, the Content Distributor 310 signs the verification message.

At block 718, the Content Distributor 310 sends, to the user node, the content key, the one-time content license identifier, and the signed verification message. At block 720, the process completes.

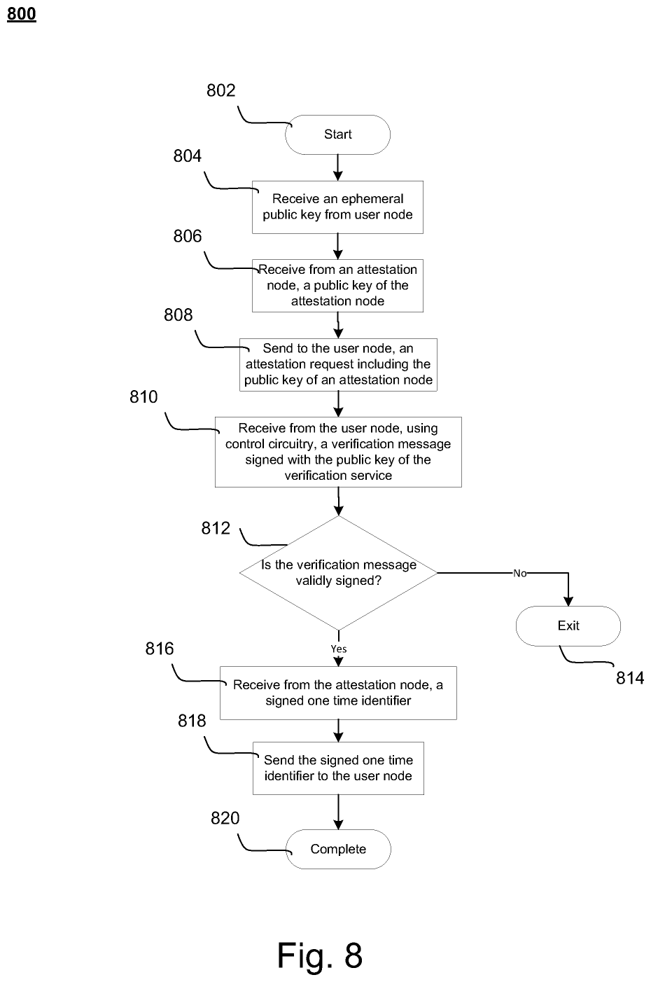

FIG. 8 is a flowchart of an illustrative process 800 which occurs at the Identification Service 304 and may correspond with that shown in FIG. 3 and FIG. 4.

At block 802, the process starts. At block 804, the Identification Service 304 receives an ephermal public key from a user node. The public key may optionally be a certified public key and authentication may include transactions that are not described in this scenario, related to, e.g., certificate chain checking. This request may be received from a user 302 which requests, with an ephemeral public key, at least one signed one-time identifier (‘SOTI’) from the identification service 304. The process advances to block 806. At block 806, the Identification Service 304 receives, from an attestation node, a public key of the attestation node. The attestation node may be the Attestation Service 306 described herein and with reference to PHASE A 316 of FIG. 3, and MSG02, MSG03, and MSG04.

At block 808, the Identification Service 304 sends, to the user node, an attestation request including the public key of the attestation node or Attestation Service 306. The process then advances to block 810. The Identification Service 304 may verify the user's signature and may then pass encrypted attestation evidence information to the Attestation Service 306. In some cases, the signature verification may be delegated to the Attestation Service 306. Often-used signature algorithms are RSA and ECDSA. In an example, the Identification Service 304 can also delegate the signature checking to the Attestation Service 306, which can also combine device integrity verification with the signature verification.

At block 810, the Identification Service 304 receives, from the user node, a verification message signed with the public key of a Verification Service 306, and advances to block 812, at which a determination is made as to whether the verification message is validly signed. If the verification message is not validly signed, the process advances to block 814 and exits. If the verification message is validly signed, the process advances to block 816.

At block 816, the Identification Service 304 receives, from the attestation node, a signed one-time identifier and sends, at block 818, the signed one-time identifier to the user node. The user node may be associated with the User 302. The process advances to block 820 and completes.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The actions or descriptions described herein may be done in any suitable alternative orders or in parallel to further the purposes of this disclosure.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be effected to the particular embodiments by those of skill in the art without departing from the scope of the present application, which is defined solely by the claims appended hereto.

1. A method for distributing content, the method comprising:
receiving at a content distribution node and using control circuitry, a content request from a user node, the content request including a content identifier and a user identifier, wherein the user identifier further comprises a public key of a user and a signed one-time identifier;
in response to determining, using control circuitry, whether a signature used to sign the signed one-time identifier is valid, the method further comprising:
generating, using control circuitry, a content supplier request, from the content request;
sending from the content distribution node and using control circuitry, the content supplier request and the user identifier to a content supply node;
receiving at the content distribution node and using control circuitry, a content reply from the content supply node, the content reply comprising a content encryption key and a content license identifier associated with the content supplier request and the signed one-time identifier;
generating at the content distribution node and using control circuitry, a verification message from the signed one-time identifier, and the content license identifier, signing the verification message using a content distributor key; and
sending from the content distribution node to the user node, the content encryption key, the content license identifier, and the signed verification message.

2. The method of claim 1, wherein the user identifier further includes a seed value for modification of the signed one-time identifier.

3. The method of claim 1, wherein the verification message is calculated and signed in a trusted execution environment.

4. The method of claim 1, wherein the method further comprises:
receiving at the content distribution node and using control circuitry, a license verification request from the user node for a license stored on the user node;
determining, using control circuitry, whether a license associated with the license verification request from the user node is a duplicate license; and
in response to determining that the license is a duplicate license:
sending, using control circuitry, a request to the user node to modify the license on the user node; and
sending, to a reporting node, using control circuitry, a notification that the license is a duplicate license.

5. The method of claim 4, wherein the request to the user node to modify the license on the user node is a request to delete the license on the user node.

6. The method of claim 1, wherein the content reply is sent in a content decryption package.

7. The method of claim 6, wherein the content decryption package is encrypted.

8. The method of claim 7, wherein the method further comprises:
receiving at the content distribution node and using control circuitry, a verification request from a user node for a content decryption package stored on the user node, the verification request including the content decryption package;
decrypting, using control circuitry, the content decryption package;
decrypting, using control circuitry, the content encryption key, one-time content license identifier, and signed verification message; and
determining, using control circuitry, that the decryption of both the content decryption package and the content encryption key, the one-time content license identifier, and the signed verification message were decrypted successfully; and
in response to determining that both the content decryption package and the content encryption key, the one-time content license identifier, and the signed verification message were not decrypted successfully:
sending, using control circuitry, a request to the user node to modify the content decryption package on the user node; and
sending, to a reporting system and using control circuitry, a notification that the content decryption package is a duplicate content decryption package.

9. The method of claim 8, wherein the request to the user node to modify the content decryption package on the user node is a request to delete the content decryption package on the user node.

10. A method for verifying a user, the method comprising:
receiving at an identification node, from a user node and using control circuitry, an ephemeral public key;
receiving, at the identification node, from an attestation node, a public key of the attestation node;
sending from the identification node and using control circuitry, to the user node, an attestation request including the public key of an attestation node;
receiving at the identification node, from the user node, using control circuitry, a verification message signed with the public key of the attestation node;
in response to determining, using control circuitry, that the verification message is validly signed:
receiving, using control circuitry, from the attestation node, a signed one time identifier; and
sending, using control circuitry, the signed one time identifier to the user node.

11. The method of claim 10, wherein the method further comprises:
generating at the identification node and using control circuitry, an unsigned one-time identifier.

12. The method of claim 11, wherein the unsigned one-time identifier is generated from a seed value.

13. A system comprising control circuitry of a content distribution node configured to:
receive a content request from a user node, the content request including a content identifier and a user identifier, wherein the user identifier further comprises a public key of a user and a signed one-time identifier;
determine whether a signature used to sign the signed one-time identifier is valid, and in response to determining it is valid,
generate a content supplier request, from the content request;
send the content supplier request and the user identifier to a content supply node;
receive a content reply from the content supply node, the content reply comprising a content encryption key and a content license identifier associated with the content supplier request and the signed one-time identifier;
generate a verification message from the signed one-time identifier, and the content license identifier, and signing the verification message using a content distributor key; and
send to the user node the content license identifier, and the signed verification message.

14. The system of claim 13, wherein the user identifier further includes a seed value for modification of the signed one-time identifier.

15. The system of claim 13, wherein the verification message is calculated and signed in a trusted execution environment.

16. The system of claim 13, wherein the control circuitry is further configured to: receive a license verification request from the user node for a license stored on the user node;
determine whether a license associated with the license verification request from the user node is a duplicate license; and
in response to determining that the license is a duplicate license:
send a request to the user node to modify the license on the user node; and
send, to a reporting node, a notification that the license is a duplicate license.

17. The system of claim 16, wherein the request to the user node to modify the license on the user node is a request to delete the license on the user node.

18. The system of claim 13, wherein the content reply is sent in a content decryption package.

19. The system of claim 18, wherein the content decryption package is encrypted.

20. The system of claim 19, wherein the control circuitry is further configured to:
receive a verification request from a user node for a content decryption package stored on the user node, the verification request including the content decryption package;
decrypt the content decryption package;
decrypt the content encryption key, one-time content license identifier, and signed verification message; and
determine that the decryption of both the content decryption package and the content encryption key, the one-time content license identifier, and the signed verification message were decrypted successfully; and
in response to determining that both the content decryption package and the content encryption key, the one-time content license identifier, and the signed verification message were not decrypted successfully:
send a request to the user node to modify the content decryption package on the user node; and
send, to a reporting system, a notification that the content decryption package is a duplicate content decryption package.

21-60. (canceled)
